(19) United States
(12) Patent Application Publication
(10) Pub. No.: US 2017/0007869 A1
(43) Pub. Date: Jan. 12, 2017

(54) Sprinkler Head Cover

(71) Applicants: Hisayoshi OHKOSHI, Tokyo (JP); SENJU SPRINKLER CO., LTD., Tokyo (JP)

(72) Inventor: Hisayoshi OHKOSHI, Tokyo (JP)

(73) Assignee: SENJU SPRINKLER CO., LTD., Tokyo (JP)

(21) Appl. No.: 15/123,719

(22) PCT Filed: Mar. 7, 2014
(86) PCT No.: PCT/JP2014/055973

§ 371 Date: Sep. 6, 2016

(51) Int. Cl. A62C 35/68; A62C 37/12; B05B 15/00

(52) U.S. Cl. CPC A62C 35/68; B05B 15/001; A62C 37/12

(57) ABSTRACT

A sprinkler head cover includes: a tubular housing connected to a sprinkler head; a cover plate installed below the housing; and a fusible alloy interposed between the housing and the cover plate. The fusible alloy is constituted of a solder piece having a predetermined shape. The fusible alloy is joined to the housing or the cover plate via an adhesive member installed on a surface of the fusible alloy.

### TECHNICAL FIELD

The present invention relates to a sprinkler head cover in which a cover plate covers a sprinkler head during normal times and in which the cover plate drops off to expose the sprinkler head at the time of a fire.

### BACKGROUND ART

Examples of a sprinkler head cover according to the related art include a sprinkler head cover in which a cover plate is joined to the lower end of a tubular housing (see Patent Literatures 1 and 2, for example).

A sprinkler head cover 100 illustrated in FIG. 6 is composed of a tubular housing 101 and a disk-shaped cover plate 102. The housing 101 is constituted of an elastic member, and can house a sprinkler head SH inside. Lugs 103 are formed at the upper portion of the inner peripheral portion of the housing 101 to project downward. The lugs 103 can be threadably engaged with a spiral groove R provided in the outer peripheral surface of the sprinkler head SH.

A plurality of legs 104 are formed at the lower end of the housing 101 to extend downward. The distal ends of the legs 104 are bent to form connection portions 105 for connection with the cover plate 102. The connection portions 105 are connected to the cover plate 102 by fusible alloys 106. At the time of a fire, the fusible alloys 106 are melted, and the cover plate 102 drops off from the connection portions 105 to expose the sprinkler head SH which is housed in the housing 101.

When joining the cover plate 102 and the joint portions 105 to each other in the sprinkler head cover 100 described above, the cover plate 102 and the joint portions 105 are soldered using the fusible alloys 106 in a molten state to be joined to each other. To this end, the cover plate 102 and the housing 101 which includes the joint portions 105 are made of a solderable material such as copper or brass. Alternatively, the surfaces of the housing 101 and the cover plate 102 are subjected to a surface treatment such as copper plating in order to make the surfaces solderable.

### CITATION LIST

### Patent Literature

PTL 1: Japanese Unexamined Patent Application Publication No. 2011-172653

PTL 2: Japanese Unexamined Patent Application Publication No. 2005-270155

### SUMMARY OF INVENTION

### Technical Problem

In the process of the soldering described above, the fusible alloys 106 are heated into a molten state, the fusible alloys 106 in the molten state are applied to the joint portions 105 and the cover plate 102, and a waiting time is required before the fusible alloys 106 are cooled to be solidified. Thus, the sequence of processes takes time.

Further, there may occur a joint failure depending on the conditions such as the temperature at which the fusible alloys 106 are melted, the cooling time, and the choice of a flux, the skills of the worker, and so forth. It is difficult to determine an internal joint failure of the fusible alloys by the appearance, and the cover plate 102 may thereafter be peeled off from the joint portions 105 if the joint strength is insufficient because of a joint failure.

In view of the foregoing problem, the present invention has an object to provide a sprinkler head cover in which a cover plate drops down because of heat of a fire and in which a process of joining a housing and the cover plate to each other can be simplified.

### Solution to Problem

In order to achieve the foregoing object, the present invention provides the following sprinkler head cover.

That is, the sprinkler head cover includes a tubular housing connected to a sprinkler head, a cover plate installed below the housing, and a fusible alloy interposed between the housing and the cover plate; the fusible alloy is constituted of a solder piece having a predetermined shape; and the fusible alloy is joined to the housing or the cover plate via an adhesive member installed on a surface of the fusible alloy.

With this configuration, in which the housing and the cover plate are joined to each other via the adhesive member which is installed on the surface of the fusible alloy, a process of heating the fusible alloy to melt the fusible alloy and a process of cooling the fusible alloy in a molten state to solidify the fusible alloy can be omitted from the process of joining the housing and the cover plate to each other according to the related art. Further, the configuration eliminates work that requires workers to be skilled such as soldering of the fusible alloy, and also reduces working conditions. Thus, the processes are simplified, and the work can be performed more easily than the related art.

A sheet piece, both surfaces of which an adhesive has been applied to or infiltrated into, may be installed on the surface of the fusible alloy to be used as the adhesive member described above. Alternatively, an adhesive in a jelly form or with a high viscosity may be used as the adhesive member. With such configurations, it is possible to prevent the adhesive from being dripped onto an unnecessary portion, and to bond only the necessary portion. Thus, the working efficiency in the process of joining the housing and the cover plate to each other can be improved.

In the present invention, a plurality of joint portions to be joined to the cover plate may be formed at a lower portion of the housing. This enables the housing and the cover plate to be installed via a predetermined space. The space allows taking an air current into the housing.

If a heat insulating layer is provided between the housing and the fusible alloy, in addition, heat transmitted from the cover plate to the fusible alloy can be accumulated in the fusible alloy with the heat insulating layer blocking transmission of the heat, which provides the effect of promoting melting of the fusible alloy.

If the adhesive member is elastic, further, breakage of the fusible alloy or the adhesive member can be prevented with the adhesive member which is elastic absorbing or mitigating a shock in the case where the sprinkler head cover is dropped by mistake.

If the adhesive member is curable by ultraviolet rays, the fusible alloy can be immediately joined to the housing and the cover plate.

### Advantageous Effects of Invention

With the present invention, the fusible alloy can be joined to the housing and the cover plate, without melting the fusible alloy, by joining the fusible alloy to the housing and the cover plate using the adhesive member. Thus, the process of joining the housing and the cover plate to each other can be simplified.

### BRIEF DESCRIPTION OF DRAWINGS

FIG. 1 is a sectional view illustrating a sprinkler head cover according to a first embodiment mounted to a sprinkler head.

FIG. 2 is a plan view of the sprinkler head cover according to the first embodiment.

FIG. 3 is an exploded sectional view taken along the line X-X of FIG. 2.

FIGS. 4(a) and 4(b) are a sectional view and a plan view, respectively, illustrating a modification in which a cover plate and a fusible alloy are joined to each other using an adhesive.

FIG. 5(a) is a perspective view of a fusible alloy according to a second embodiment, and FIG. 5(b) is a sectional view of an essential portion around the fusible alloy according to the second embodiment.

FIG. 6 is a sectional view of a sprinkler head cover according to the related art.

### BEST MODES FOR CARRYING OUT THE INVENTION

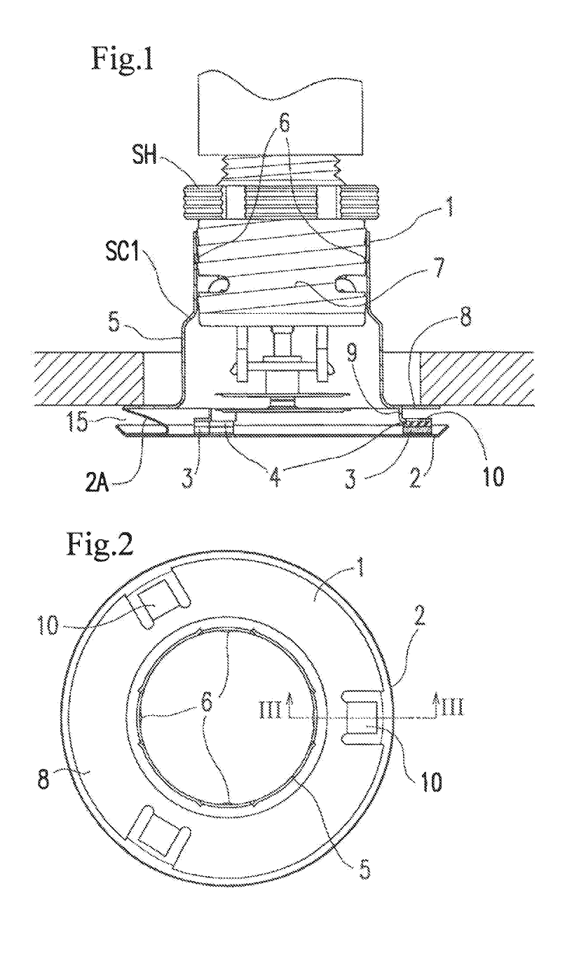

### First Embodiment (FIGS. 1 to 4)

A sprinkler head cover SC1 according to an embodiment of the present invention includes a housing 1, a cover plate 2, fusible alloys 3, and joint members 4.

The housing 1 is tubular, and a tubular portion 5 of the housing 1 has a structure for engagement with a sprinkler head SH. Specifically, a plurality of lugs 6 for engagement with the sprinkler head SH are installed on the inner peripheral side of the tubular portion 5. The lugs 6 can engage with a spiral groove 7 formed in the outer peripheral portion of the sprinkler head SH. Rotating the housing 1 can move the lugs 6 along the spiral groove 7 to move the housing 1 up and down in FIG. 1.

A flange portion 8 is formed below the tubular portion 5 to extend outward. In FIGS. 1 and 2, the flange portion 8 is formed over the entire circumference of the tubular portion 5. However, the present invention is not limited thereto, and the flange portion 8 may be formed partially at several locations of the tubular portion 5. As illustrated in FIG. 1, the flange portion 8 is disposed at a position proximate to the lower surface of a ceiling.

Legs 9 are formed in the vicinity of the flange portion 8 to extend downward. The distal ends of the legs 9 are bent to serve as connection portions 10 for connection with the cover plate 2. The connection portions 10 are bent so as to be generally parallel to the flange portion 8. The connection portions 10 are stepped from the flange portion 8 so that the housing 1 and the cover plate 2 can be installed via a predetermined space 15. The space allows taking an air current into the housing 1.

The cover plate 2 is formed from a thin metal plate. Specifically, the cover plate 2 is formed from brass or copper to easily absorb heat at the time of a fire. A surface (lower surface in FIG. 1) of the cover plate 2 exposed to the room side has been subjected to a surface treatment such as painting or plating.

A plate spring 2A is installed between the cover plate 2 and the flange portion 8. The plate spring 2A has a function of urging the cover plate 2 to drop down when the fusible alloys 3 are melted by heat of a fire.

The fusible alloys 3 are interposed between the connection portions 10 of the housing 1 and the cover plate 2. The fusible alloys 3 are alloys with a melting point lower than the operating temperature of the sprinkler head SH. In the case where the operating temperature of the sprinkler head is 72° C., the fusible alloys 3 with a melting temperature of 50 to 65° C. may be used.

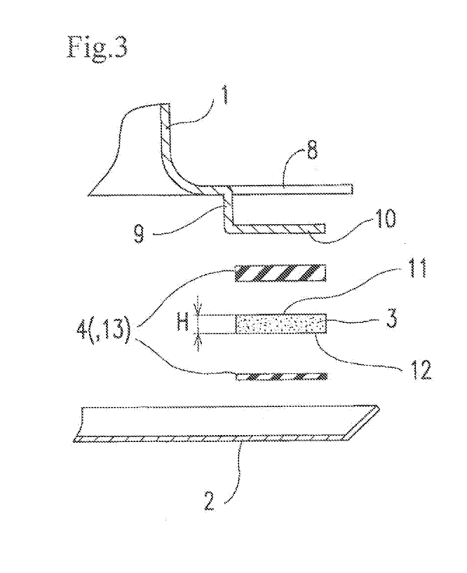

The fusible alloys 3 are rectangular parallelepiped, and each has a first surface 11 to be connected to the connection portion 10 and a second surface 12 provided opposite to the first surface 11 to be connected to the cover plate as illustrated in FIG. 3. Adhesive members 4 are installed on the surfaces of the first surface 11 and the second surface 12.

In the embodiment, one fusible alloy 3 is installed for each connection portion 10 of the housing 1. In this event, a clearance may be formed between the connection portions 10 and the cover plate 2 if the thickness H of the fusible alloys 3 is not uniform. The joint between the connection portions 10 and the cover plate 2 is stabilized by making the thickness H of the fusible alloys 3 uniform.

By making the respective volumes of the fusible alloys 3 uniform, it is possible to prevent fluctuations in timing when the fusible alloys 3 at the connection portions 10 are melted by heat of a fire. Further, increasing the surface areas of the fusible alloys 3 allows the fusible alloys 3 to easily absorb heat of a fire, which allows the fusible alloys 3 to be melted to cause the cover plate 2 to drop down in the initial stage of the fire. Specific examples of a method of increasing the surface areas of the fusible alloys 3 include forming grooves or holes in the side surfaces of the fusible alloys 3.

The adhesive members 4 join the fusible alloys 3 to the connection portions 10 and the cover plate 2. Examples of the adhesive members 4 include two-sided tapes 13. The two-sided tapes 13 are sheet pieces in which an adhesive has been applied to or infiltrated into the surfaces of a base material such as a film, paper, or cloth. In the case where an adhesive is directly applied to the surfaces of the connection surfaces 10 and the first surfaces 11 of the fusible alloys 3, the adhesive may be dripped to adhere to an unnecessary portion such as the side surfaces of the fusible alloys 3. However, use of the two-sided tapes 13 allows only the connection portions 10 and the first surfaces 11 to be joined to each other.

Use of an elastic material for the base material of the two-sided tapes 13 allows absorbing or mitigating an impact because of the elasticity of the adhesive members even if the sprinkler head cover SC1 is dropped by mistake. This prevents the fusible alloys 3 or the adhesive members 4 from being deformed, cracked, chipped, or the like.

The two-sided tapes 13 are applied to the first surfaces 11 and the second surfaces 12 of the fusible alloys 3 discussed earlier so that the fusible alloys 3 are joined to the connection portions 10 and the cover plate 2. In this event, the two-sided tapes 13 to be applied to the first surfaces 11 are preferably thicker than the two-sided tapes to be applied to the second surfaces 12. This allows the two-sided tapes 13 applied to the first surfaces to serve as a heat insulating layer to provide the effect of urging the fusible alloys 3 to be melted by accumulating heat in the fusible alloys 3 by not allowing heat transmitted from the cover plate 2 to the fusible alloys 3 to be easily transferred to the connection portions 10.

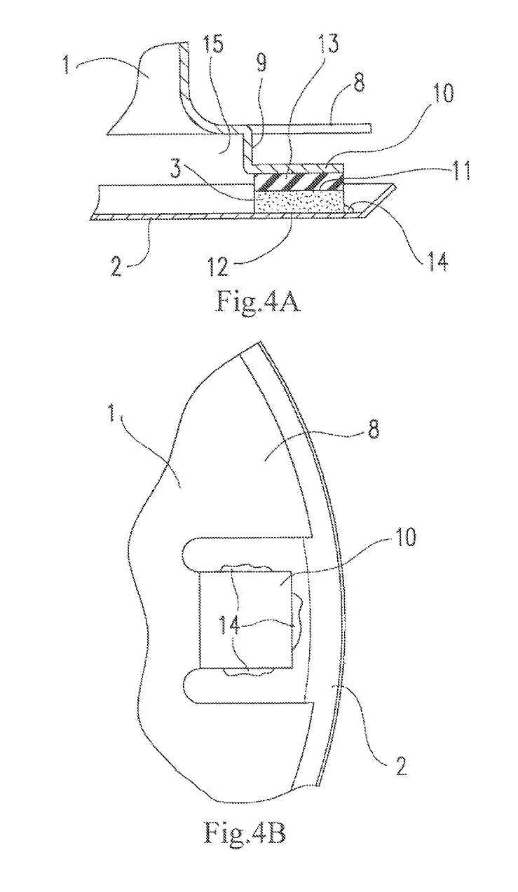

In a modification to the above, an adhesive 14 may be used in place of the two-sided tapes 13. Use of the adhesive 14 with a high viscosity or in a jelly form prevents the adhesive 14 from being dripped to an unnecessary portion. As illustrated in FIG. 4, the adhesive 14 is applied to the edge of the second surface 12 of the fusible alloy 3 using a dispenser or the like with the cover plate 2 and the second surface contacting each other. Applying the adhesive 14 to the edge of the second surface 12 allows the upper surface of the cover plate 2 and the lower portions of the side surfaces of the fusible alloy 3 to be joined to each other. In FIG. 4, the adhesive 14 is applied to three locations at the edge of the second surface. However, the adhesive 14 may be applied to the entire periphery of the edge of the second surface.

When the cover plate 2 and the lower portions of the side surfaces of the fusible alloys 3 are joined to each other using the adhesive 14, the second surfaces 12 and the cover plate 2 directly contact each other. Thus, heat absorbed by the cover plate 2 is directly transmitted to the fusible alloys 3, which can shorten the time required before the fusible alloys 3 are melted at the time of a fire.

If an ultraviolet-curable adhesive is used as an example of the adhesive described above, the joint work can be performed in a short time because the adhesive is immediately solidified by radiating ultraviolet rays. Use of an elastic adhesive allows absorbing or mitigating an impact because of the elasticity of the adhesive 14 even if the sprinkler head cover SC1 is dropped by mistake. This prevents the fusible alloys 3 from being deformed, cracked, chipped, or the like, and prevents the cover plate 2 from being peeled off. Use of the adhesive 14 which is thermally conductive allows heat absorbed by the cover plate 2 to be transmitted to the fusible alloys 3 via the adhesive 14, which urges the fusible alloys 3 to be melted.

The adhesive described above may be used as applied to or infiltrated into a base material as described earlier in relation to the two-sided tapes 13.

Subsequently, operation of the sprinkler head cover according to the embodiment at the time of a fire will be described.

The sprinkler head cover SC1 illustrated in FIG. 1 is engaged with the spiral groove 7 in the outer peripheral portion of the sprinkler head SH. The flange portion 8 is disposed at a position in proximity to the lower surface of a ceiling. The predetermined clearance 15 is provided between the flange portion 8 and the cover plate 2.

When a fire occurs, an air current due to the heat of the fire resides on the lower surface of a ceiling. The hot air current due to the fire passes through the cover plate 2 and the clearance 15 to reach the fusible alloys 3. The cover plate 2 and the fusible alloys 3 absorb heat from the hot air current. The heat absorbed by the cover plate 2 is also transmitted to the fusible alloys 3 to urge the fusible alloys 3 to be melted.

The adhesive members 4 (two-sided tapes 13) joined to the connection portions 10 are thicker than the adhesive members 4 adhering to the surface of the cover plate 2, and have a heat insulating effect. Thus, the heat transmitted to the fusible alloys 3 is not easily conducted to the connection portions 10. Hence, the heat is accumulated in the fusible alloys 3 to melt the fusible alloys 3.

When the fusible alloys 3 are melted, the connected state of the connection portions 10 and the cover plate 2 is canceled, and the cover plate 2 drops off because of its own weight and the function of the plate spring 2A. When the cover plate 2 drops off, the sprinkler head SH inside the housing 1 is exposed, and more heat is conducted to the sprinkler head SH to actuate the sprinkler head SH, which sprays water to extinguish the fire.

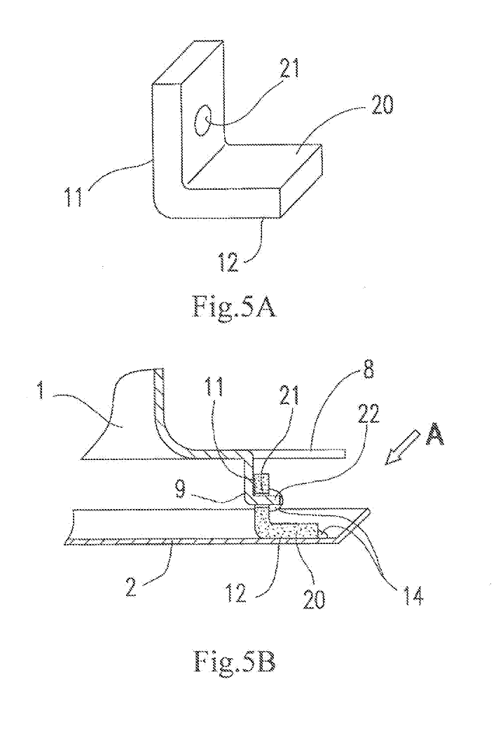

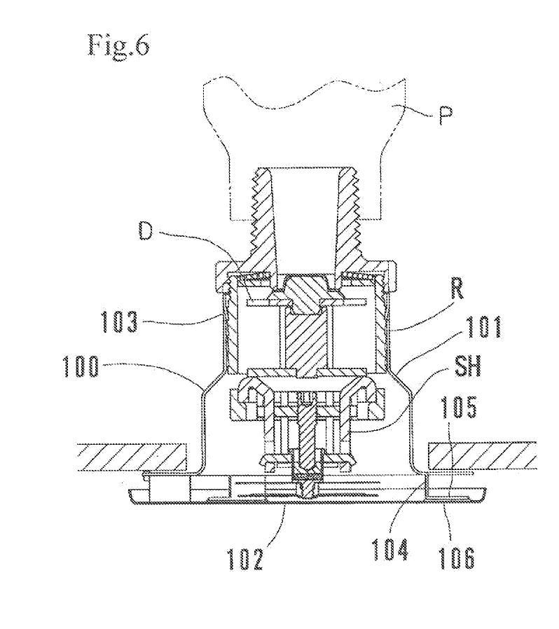

### Second Embodiment (FIG. 5)

A sprinkler head cover in which fusible alloys are formed in an L-shape according to a second embodiment of the present invention will be described. Components that are the same as those of the first embodiment are denoted by the same reference numerals to omit a detailed description thereof.

As illustrated in FIG. 5(a), a fusible alloy 20 according to the second embodiment is in an L-shape, and has been shaped by bending a plate-like fusible alloy by about 90° at an intermediate portion. A first surface 11 to be joined to the housing 1 is provided on one side with respect to the bent portion of the fusible alloy 20. A second surface 12 to be joined to the cover plate 2 is provided on the other side.

A hole 21 is provided in the first surface 11. The hole 21 receives a projection 22 formed on the leg 9 of the housing 1. The legs 9 and the fusible alloys 20 are engaged with each other when the projections 22 of the legs 9 provided at three locations of the housing 1 are inserted through the holes 21 of the fusible alloys 20.

In this state, the fusible alloys 20 are placed on the cover plate 2 on the second surfaces 12. The adhesive 14 is dripped onto the edge of the second surfaces 12 of the fusible alloys 20 to join the cover plate 2 and the fusible alloys 20 to each other.

Consequently, the fusible alloys 20 are joined to the housing 1 and the cover plate 2. In addition to the above, the adhesive 14 may be applied and solidified around the holes 21 and the projections 22 to improve the joint strength.

Use of an adhesive in a jelly form or with a high viscosity as the adhesive 14 allows the adhesive 14 to join the holes 21 and the projections 22 to each other only around the holes 21 and the projections 22 without the adhesive being dripped.

In the present invention described in relation to the first and second embodiments, the housing 1 and the cover plate 2 can be joined to each other without melting the fusible alloys 20. Thus, it is possible to reduce the work time required for heating to solidifying the fusible alloys as in the related art, and to manufacture a sprinkler head cover having a predetermined quality even if the workers are not highly skilled.

In the second embodiment, in addition to the above effect, the adhesive 14 can be applied to a portion around the hole 21 and the edge of the second surface 12 at a time using a dispenser or the like from the A direction indicated by the arrow in FIG. 5(b), which improves the working efficiency. Further, if an ultraviolet-curable adhesive is used as the adhesive 14, it is possible to shorten the time taken to solidify the adhesive by radiating ultraviolet rays after application of the adhesive.

### REFERENCE SIGNS LIST

1 Housing

2 Cover Plate

3 Fusible Alloy

4 Adhesive Member

8 Flange Portion

9 Leg

10 Connection Portion

11 First Surface

12 Second Surface

13 Two-sided Tape (Sheet Piece)

14 Adhesive

1. A sprinkler head cover comprising:
a tubular housing connected to a sprinkler head;
a cover plate installed below the housing; and
a plurality of fusible alloys interposed between the housing and the cover plate,
wherein the plurality of fusible alloys is constituted of solder pieces formed in a plate-like shape and having a uniform thickness; and
the sprinkler head cover includes adhesive members that join the solder pieces and the cover plate to each other.

2. A sprinkler head cover comprising:
a tubular housing connected to a sprinkler head;
a cover plate installed below the housing; and
the plurality of fusible alloys interposed between the housing and the cover plate,
wherein a plurality of joint portions to be joined to the cover plate are formed on the housing;
the plurality of fusible alloys is constituted of solder pieces formed in a plate-like shape and having a uniform thickness; and
the sprinkler head cover includes adhesive members that join the solder pieces and the joint portions of the housing to each other

3-9. (canceled)

10. A sprinkler head cover comprising:
a tubular housing connected to a sprinkler head;
a cover plate installed below the housing; and
a plurality of fusible alloys interposed between the housing and the cover plate, wherein
a plurality of joint portions to be joined to the cover plate are formed on the housing;
the plurality of fusible alloys is constituted of solder pieces formed in a plate-like shape and having a uniform thickness; and
the sprinkler head cover includes adhesive members that join the solder pieces and the joint portions of the housing to each other.

11. A sprinkler head cover comprising:
a tubular housing connected to a sprinkler head;
a cover plate installed below the housing; and
a plurality of fusible alloys interposed between the housing and the cover plate,
wherein a plurality of joint portions to be joined to the cover plate are formed on the housing;
the plurality of fusible alloys is constituted of solder pieces formed in a plate-like shape and having a uniform thickness; and
the sprinkler head cover includes first adhesive members that join first surfaces of the solder pieces and the joint portions of the housing to each other, and second adhesive members that join second surfaces of the solder pieces and the cover plate to each other.

12. The sprinkler head cover according to claim 1,
wherein the adhesive members are sheet pieces, both surfaces of which an adhesive has been applied to or infiltrated into.

13. The sprinkler head cover according to claim 1,
wherein the adhesive members are adhesives in a jelly form or adhesives with a high viscosity.

14. The sprinkler head cover according to claim 1,
wherein the adhesive members are elastic.

15. The sprinkler head cover according to claim 1,
wherein the adhesive members are ultraviolet-curable adhesives.

16. The sprinkler head cover according to claim 1,
wherein the solder pieces each have a first surface for connection to a side of the housing and a second surface for connection to a side of the cover plate.

17. The sprinkler head cover according to claim 1,
wherein the adhesive members are thermally conductive adhesives.

18. The sprinkler head cover according to claim 1,
wherein the plurality of solder pieces is uniform in volume.

19. The sprinkler head cover according to claim 2,
wherein the adhesive members are sheet pieces, both surfaces of which an adhesive has been applied to or infiltrated into.

20. The sprinkler head cover according to claim 2,
wherein the adhesive members are adhesives in a jelly form or adhesives with a high viscosity.

21. The sprinkler head cover according to claim 2,
wherein heat insulating layers constituted of the adhesive members are provided between the joint portions of the housing and the solder pieces.

22. The sprinkler head cover according to claim 2,
wherein the adhesive members are elastic.

23. The sprinkler head cover according to claim 2,
wherein the adhesive members are ultraviolet-curable adhesives.

24. The sprinkler head cover according to claim 2,
wherein the solder pieces each have a first surface for connection to a side of the housing and a second surface for connection to a side of the cover plate.

25. The sprinkler head cover according to claim 2,
wherein the adhesive members are thermally conductive adhesives.

26. The sprinkler head cover according to claim 2,
wherein the plurality of solder pieces is uniform in volume.
